(19) United States
(12) Patent Application Publication
(10) Pub. No.: US 2008/0256368 A1
(43) Pub. Date: Oct. 16, 2008

(54) Method and Device For Protecting Digital Content in Mobile Applications

(76) Inventors: Andree Ross, Luenen (DE); Wolfgang Theimer, Bochum (DE)

Correspondence Address: Hollingsworth & Funk, LLC, 8009 34th Avenue South, Suite 125, Minneapolis, MN, 55425, US

(21) Appl. No.: 11/661,253

(22) PCT Filed: Sep. 23, 2004
(86) PCT No.: PCT/IB04/03095

§ 371 Date: Jan. 25, 2008

(51) Int. Cl. H04L 9/06; G06F 21/00

(52) U.S. Cl. 713/193; 726/26

(57) ABSTRACT

The present invention provides methods and devices allowing a secure way of sharing protected content. A content holder may share the content under certain restrictions. The invention offers a secure sharing method preventing copyright violations and preserving the copyright owners control over the content use, while also offering new marketing possibilities to him. A method for protecting digital content is provided which comprises receiving said digital content, encrypting said digital content using a encryption algorithm resulting in encrypted content, generating license information associated to said encrypted content, wherein said license information is provided as one or more executable code sections, which are executable on a processor-based entity.

The invention relates generally to methods for protecting digital content and devices assigned to deal with that content. Particularly, the invention relates to a method for encrypting digital content, so that after encrypting the content can freely be distributed. Additionally, the invention relates to a method to generate license information corresponding to the protected content. A device that obtains protected content requires the previously associated license information for properly usage of the content. This license information is prepared for using by means of a method in accordance with the present invention. Further, the invention proposes a system comprising the previously mentioned devices adopted to issue protected digital content and license information.

Though the spreading use of media content in digital form has many advantages regarding among others quality and ease of use, it also poses one problem, which resides in the lossless duplication associated with digital content. Since it is easy to copy digital information, copyright infringement has become a great threat to content owners.

Presently, there are many different concepts and methods available, which are provided to deal with and generate protected digital content. The digital content that has to be protected corresponds for instance, but is not limited to, to usual software applications or another imaginable content, like digital music, pictures etc. Over the time, software applications on personal computers, mobile phones or gaming consoles (in the following called “system”) have become more and more precious and an attractive business has evolved around different kinds of applications on those systems. An example is the gaming business for mobile or stationary gaming devices. If a software application has been acquired for a device, a content protection technique has to ensure that this software application is only running on that specific device and cannot be copied to another device. It has to ensure that the application code cannot be manipulated (e.g. by exchanging code instructions) to protect the data integrity. A license is required to use the code. The term license summarizes the required software components that make the protected software run on a device. Content-protected software cannot be used without valid license on the device.

Thus a protection for digital content was developed, the digital rights management (DRM). DRM utilizes encryption for the protection of media content The principles of DRM are associating usage rules with the digital content and further enforcing these rules. The raw digital information is encrypted and usually specifically assigned to a predetermined device. Consequently, the content data may not any longer be duplicated or without any restrictions be copied. This makes it possible for the provider of said digital content to control the undefined or illegal distribution of licensed content. The expression “digital content” summarizes usual content, which is well known on the market such as: ringing tones, pictures and logos, Java and Symbian applications, MIDI ring tones or even complex software applications or video clips. These issues are defined by the Open Mobile Alliance (OMA) and provided for standardization of the usage of mobile-centric content. DRM allows controlling over the usage of downloaded media objects and allows the content providers to define rules for how the content should be generally used. It makes possible to sell the rights to use the media data rather then the media object himself. The features exemplarily mentioned above shall serve to underline the context of the present invention.

The state of the art mentions three general methods for managing DRM Version 1.0 schemas in connection with digital content:
1. Forward Lock
2. Combined Delivery
3. Separate Delivery

WO 02/23311 discloses a method and system for distributing digital information. Here only the access to content is being distributed. The consumer does not obtain a copy of the content itself, but the right for playback of the information over a network.

EP 24095-034/jd relates to an architecture for enforcing rights in digital content. It describes such an enforcement architecture that allows access to encrypted digital content only in accordance with parameters specified by license rights acquired by a user of the digital content. This architecture ensures the restriction of the previously protected content but it is complicated and incomprehensible to implement and in addition to that once the encrypting algorithm were cracked, the content can freely be distributed without any restriction.

This specific security problem is also contained in the traditional DRM schemas. Even if the digital content is encrypted thus protected and an additional license object is needed once somebody cracks the encrypting algorithm the content is insecure and it can be freely used from everybody.

However, code manipulations or black copies can now be provided without controlling or maintaining issues by the original content provider.

It is very difficult to protect applications (on PCs, gaming devices, mobile devices such as mobile phones etc.) or multimedia content against illegal copying or modifications. Especially on multi-purpose systems like PCs, mobile phones or other system is having rewrite-able storage media inside it is very difficult to protect the software against modification or copying, because reverse engineering on those systems is easily possible for code manipulations, and content can easily be copied from one device to another listing CDs or and any other kind of transfer media (such as e.g. also the air interface). New software for those systems is commonly distributed using transfer media such as CDs, DVD, memory cards etc. from which the application is installed to the system or the software is directly run from the medium.

The protection technique of this invention is based on a content and license distribution model that considers license and content separately which corresponds generally to the third schema of DRM Version 1.0 (see itemization above).

This invention introduces a content protection technique that protects digital content against illegal usage (including transfer from one device to another device) as well as a protection technique that protects against code and data manipulations, so that the data and code integrity can be ensured. It addresses the problem for security of games and other content, which must not be usable even if one content-protected version has been cracked and has e.g. been published in the Internet. Content can be distributed via any kind of physical medium (CD, DVD etc.) or over-the-air (OTA). A license is required to activate the protected software on a specific device; the license can be distributed separately from the content, but a license is always required to make protected software run. Furthermore, the invention provides an additional content protecting technique, which makes even cracked encrypted content unreadable thus not usable.

One main advantage of the present invention is that the subscribed licenses are device-related, so that licenses can be copied without harm, as licenses do only work for one specific device. The license data, sent to the user is encrypted applying an asymmetric encryption approach, which is very difficult to hack. By means of encrypting or scrambling respectively methods in accordance with the present invention the digital content is additionally secured against copying and manipulations. Even if somebody hacks the (freely distributed) protected content it cannot be used because the additional data ensuring mechanism in accordance with the present invention intervenes.

One idea of this invention is based on the fact that manipulated content can be copied freely from device to device, because the content cannot be used until it is repaired. A license is required that enables a device to repair the content efficiently just before usage, so that it can be used. A license is assigned to a specific device applying an asymmetric encryption approach, so that even licenses can be copied freely, because a once assigned license will only work for that one specific device the license has been assigned to. To enable a distinction between manipulated and normal content a device has to be capable of recognizing manipulated content, so that the device enables the usage of dedicated APIs that repair the content in a tamper-resistant area and perform tamper-resistant license decryption operations.

Furthermore, the recognition of manipulated content is also required to enable the automatic download of licenses e.g. if the license is not available on the device.

This invention thus also introduces a general tagging mechanism for content, so that content can be identified (regardless of any manipulation) and the usage of content can be restricted to vendor subgroups if wanted. Every vendor that is allowed to publish content (such as e.g. applications, movies, music etc.) for a device needs to have a signed certificate. The signature for the certificate is given by one major controlling instance, e.g. the owner of the data.

The de-scrambling or decrypting algorithm (e.g. given as executable program code) and the removed scrambled content segments are components of the license that enables a device to make the protected content run.

According to a first aspect of the present invention, a method for protecting digital content is provided. The method comprises receiving said digital content and subsequently encrypting of said digital content by using an encrypting algorithm resulting in encrypted content. Afterwards follows generating of license information associated to the encrypted content, wherein said license information is provided as one or more executable code sections, which are executable on a processor-based entity.

The generated license information as an executable object is a main advantage of the present invention. Said executable object allows the implementation of several encrypting scenarios, because it acts like an independent application, which is easy to enhance.

It is preferred that one or more content segments from said encrypted content are removed. This entails a better protection against copying of the content. Said removed one or more content segments are stored for further usage. By providing said protected content with a protected content tag an advantageous identification of the protected content is possible. Providing of the protected content and of the license information corresponds to a step of sharing data.

It is preferred that the protected content is identifiable regardless of any manipulations caused by unauthorized parties. This ensures code and data integrity.

It is preferred that the protected content is tagged for restricted usage of said content, wherein said tag is associated with one or more originators. This is convenient in case of tracing and restricting of the usage of the protected content.

It is preferred that the originators are providing protected content. This is a usual step to provide protected content.

According to another aspect of the present invention a method for preparing license information for a license-requesting entity is provided. The method comprises the steps of receiving of said license information and receiving a request for providing license information from said license-requesting entity. This request has the consequence that said license information will be assigned to said specific license-requesting entity by using an asymmetric encryption algorithm, said license information resulting in an encrypted license information.

It is preferred that the encrypted license information is sent. This is a usual step required during the communication between two entities.

It is preferred that the encrypted license information comprises code sections, which are executable exclusively on a processor-based entity. This entails convenient usage of the encrypted license information, thus it is possible to provide the encrypted license information as a executable software application.

It is preferred that the encryption of the license information is based on an asymmetric public/private key infrastructure, wherein the private key is secret and the public key is freely distributable. This serves for better compatibility between the participating entities.

It is preferred that the private key is associated with said license-requesting entity. This ensures the uniqueness of the license-requesting entity.

According to another aspect of the present invention a method for using protected content is provided, wherein said protected content is encrypted. The received license information originates from a license-providing entity, and the license information is provided as one or more executable code sections, which are executable on a processor-based entity. Afterwards follows executing of the license information in response to which said protected content is decrypted, thereby obtaining a digital content.

It is preferred that the method detects that said protected content is encrypted and subsequently sends a request to a specific license-providing entity in response to said detection in order to receive said license information. If the license information is destined for a different license-requesting entity, rejecting of the license information follows.

If the protected content additionally is deprived of one or more content segments, the license information is able to re-assemble the missing content segments after executing the license information.

It is preferred that the license information is previously encrypted based on an asymmetric public/private key infrastructure, wherein the private key is secret and the public key is freely distributable, thereby obtaining encrypted license information. This allows an entity-related association of the license information. Just the owner of the private key is able to decrypt the data.

It is preferred that the license information is device-related. This enables the uniqueness of the license information.

It is preferred that an additional step of identifying an assigned content provider is provided with respect to the digital content, which is previously identified with an originator associated tag. This allows the secure identification of a specific content provider.

It is preferred that the sending of the request data is dependent on a user confirmation operation. This allows permanent user control.

It is preferred that the re-assembling of the previously removed content is provided with respect to the information contained in said encrypted license information. This is a normal step when using protected content in combination with the corresponding license information and it ensures proper usage.

It is preferred that a dummy decryption algorithm is activated that just passes through content if no license data is available. This is also a normal step for handling digital content and protected content as well.

It is preferred that the dummy decryption algorithm passes through the protected content to another entity without any processing if no license data is available. This allows the identification of the protected content that is previously encrypted.

According to another aspect of the present invention a computer program for handling protected content is provided, comprising program code sections for carrying out the steps of anyone of the aforementioned claims, when said program is run on a computer, a microprocessor based device, a terminal, a network device, a mobile terminal, or a portable communication enabled terminal. Special software is essential for the invention, to provide a closed system on either side of the process.

According to another aspect of the present invention a computer program product for handling protected content is provided, comprising program code sections stored on a machine-readable medium for carrying out the steps of anyone of the aforementioned claims, when said program product is run on a computer, a microprocessor based device, a terminal, a network device, a mobile terminal, or a portable communication enabled terminal.

According to another aspect of the present invention a software tool for handling protected content is provided, comprising program portions for carrying out the operations of any one of the aforementioned claims, when said program is implemented in a computer program for being executed on a microprocessor based device, processing device, a terminal device, a network device, a mobile terminal, or a portable communication enabled terminal.

According to another aspect of the present invention a computer data signal is provided, embodied in a carrier wave and representing a program that instructs a computer to perform the steps of the method of anyone of the aforementioned claims. Thereby travelling code sections can contain instructions for executing the invention.

According to a first embodiment of the present invention a content managing system for managing use of protected content having license information associated therewith is proposed. The license information provides restricted usage of said protected content. The aforementioned system comprises:
a mobile electronic terminal device adapted to allow usage of said protected content and said license information associated therewith;
a protected server adapted to maintain said license information;
means for receiving a license request from said mobile electronic terminal device, wherein said means comprises a identification procedure of said mobile electronic terminal device;
means for sending said license information associated to at least one license-requesting mobile electronic terminal device.

It is preferred that the mobile electronic terminal device comprises a plurality of devices, each of said devices comprising a public key used by said identification procedure. This allows the use in a wide and extensive system.

According to a second embodiment of the present invention an encrypting unit for generating protected content, corresponding to a digital content, and generating associated license information is proposed.

This unit comprises the following modules:
a receiver adapted to receive said digital content;
an encrypting module adapted to encrypt said digital content using an encrypting algorithm resulting in encrypted content;
a license information generator adapted to generate license information associated to said protected content, wherein said license information is provided as one or more executable code sections, which are executable on a processor-based entity.

It is preferred that the encrypting unit further comprises:
a removing module adapted to remove one or more content segments from said encrypted content resulting in protected content;
a tagging module adapted to provide said protected content with a protected content tag to enable identification of said protected content; and
means for providing said protected content and said license information.

Thus, an enhanced and proper functionality of the encrypting unit is possible.

According to a third embodiment of the present invention a server unit for preparing license information is proposed. Said server unit comprises:
a receiver adapted to receive said license information;
a receiver adapted to receive a request for providing license information from said specific license-requesting mobile unit;
a license information assigning module adapted to assign said license information to said specific license-requesting entity using an asymmetric encryption algorithm resulting in an encrypted license information; and
a transmitter adapted to send said encrypted license information to said license-requesting mobile unit.

According to a fourth embodiment of the present invention a mobile unit for using protected content is introduced. Said mobile unit comprises:
means for receiving protected content;
means for receiving a license information from a license-providing entity, wherein said license information is associated to said encrypted content, wherein said license information is provided as one or more executable code sections, which are executable on a processor-based entity; and
means for executing said license information in response to which said protected content is decrypted, thereby obtaining a digital content.

It is preferred that the mobile unit further comprises means for detecting that said protected content is encrypted and sending a request to a specific license-providing entity in response to said detection in order to receive said license information and means for rejecting said license information if said license information is destined for a different license-requesting entity. This is convenient for a user and ensures as well that the content is only used by the destined entity.

It is preferred that the mobile unit further comprises means for executing said license information in response to which said protected content is decrypted, and re-assembling of the received one or more content segments, thereby obtaining said digital content, wherein said one or more content segments are included in said license information. This means are used if the protected content additionally is deprived of one or more content segments.

It is preferred that the mobile unit for using protected content is provided with an identifier which allows the identification of an assigned content provider on the basis of said protected digital content, which is previously identified with a originator associated tag, wherein said originator tag is associated with content provider. This allows the restricted usage of digital content respectively protected content by the mobile unit.

In the following, the present invention will be described in greater detail with reference to embodiments and the accompanying drawings, in which:

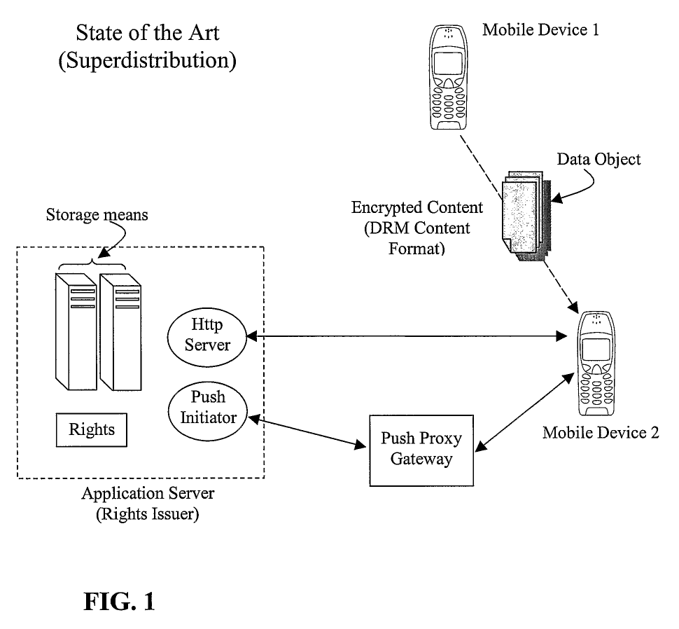

FIG. 1 illustrates the state of the art in case of the superdistribution of content.

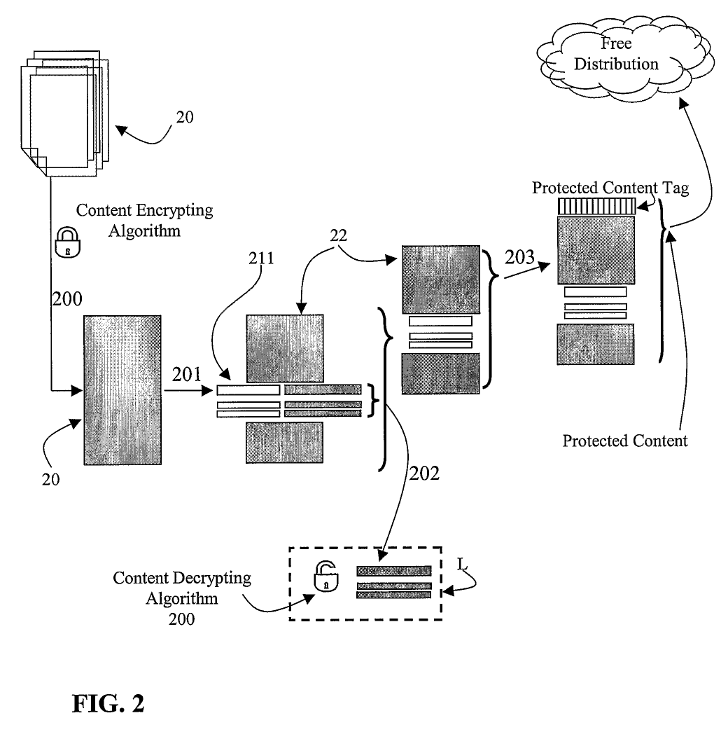

FIG. 2 illustrates the content preparing principle of the digital content to be protected.

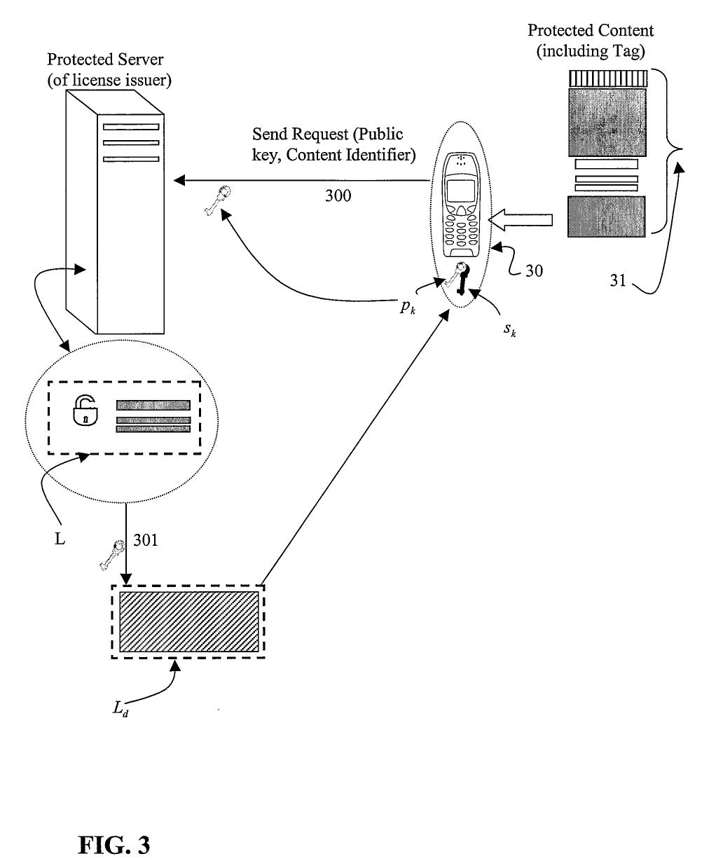

FIG. 3 shows the communication principle between a mobile device and a license issuer, in form of a protected server device.

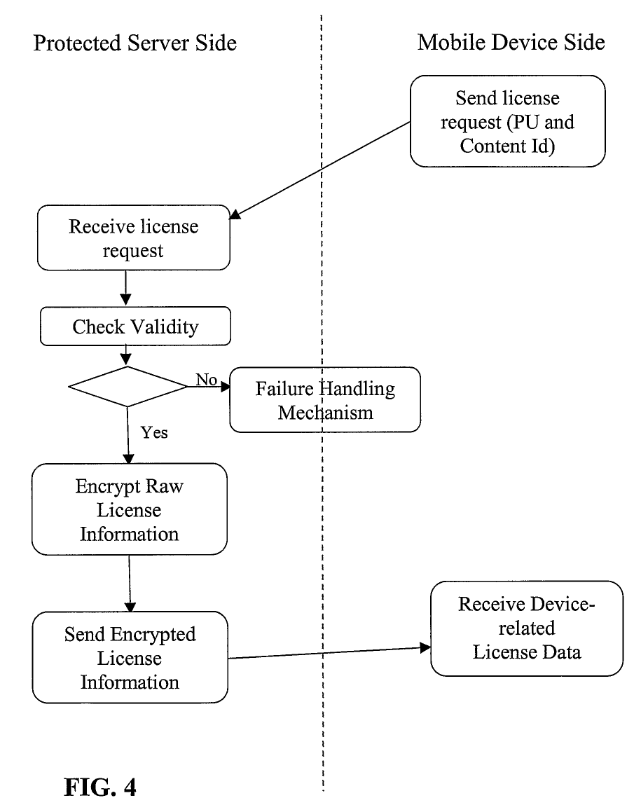

FIG. 4 is a flow diagram describing the exact data flow in case of a license-requesting operation.

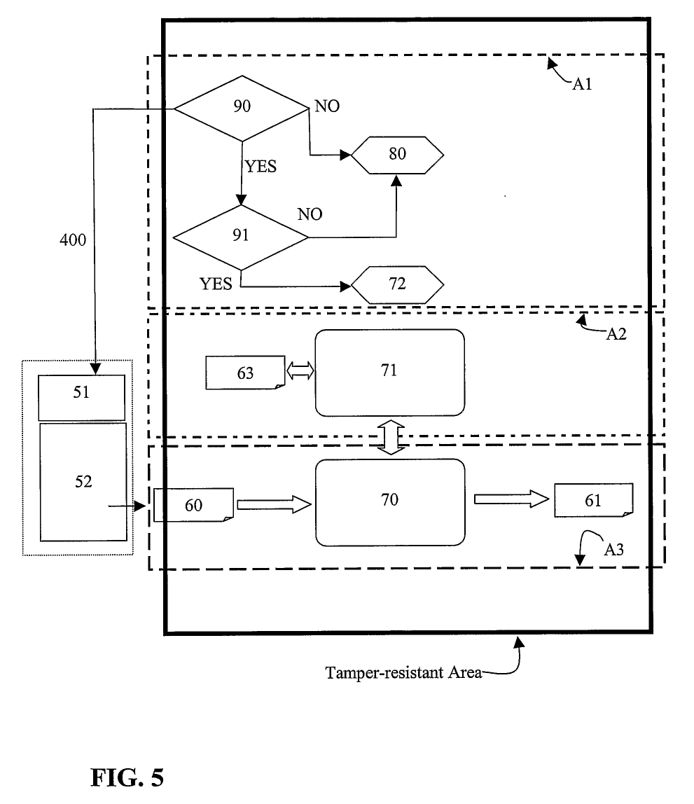

FIG. 5 shows a general content protection concept of the present invention.

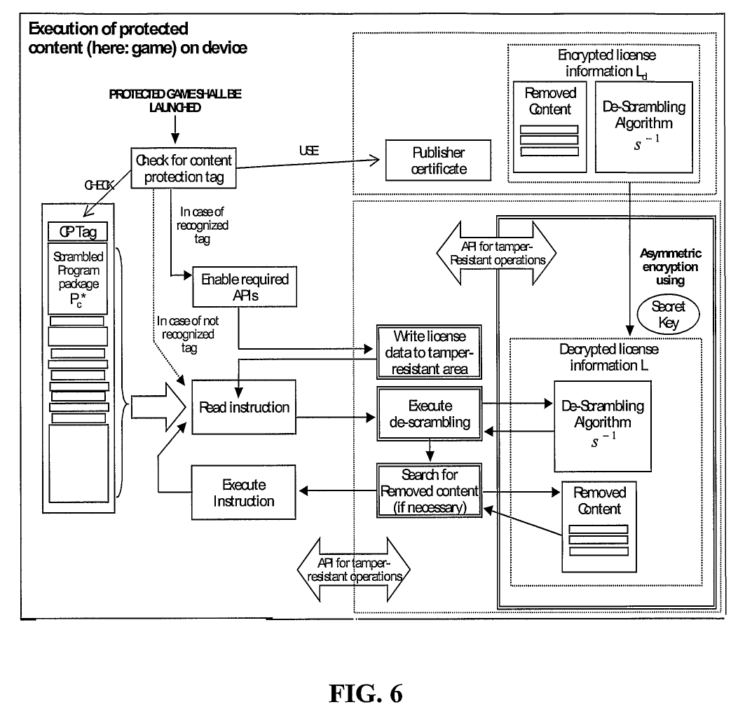

FIG. 6 schematically shows the processing and execution of protected content on a device.

Throughout the detailed description and the accompanying drawings same or similar components, units or devices will be referenced by same reference numerals for clarity purposes.

In FIG. 1 sharing of DRM rights according to the state of the art is schematically illustrated. The data object was previously encrypted into DRM content format (DCF). The first mobile terminal device 1 that has formerly received the (DCF) data object is able to share this object with a second mobile terminal device 2. The protected content in form of a DCF file can also be distributed via an insecure transport, for instance MMS transfer, HTTP download or similar) but not the rights object. This means that the second device is not able to use the protected content package because the rights object is missing. The rights object contains all the data that is needed to make the protected content usable. This rights object is to be distributed via a more secure transport because it contains the content encryption key (CEK) needed to decrypt the DCF file. FIG. 1 schematically shows the principle of super distribution. The superdistribution corresponds to an application of the separate delivery method. This means, the data and the rights object respectively license data are separately delivered. In case of superdistribution the content is transmitted from person to person respectively from one device to another. The application server side in accordance with FIG. 1 serves as a HTTP server, a push initiator (e.g. WAP) a rights issuer and it also contains data that can be accessed by a user via a mobile terminal device. A mobile terminal device 2 that wants to access data, for instance via HTTP, will receive the rights object via a push proxy gateway, which was initiated on the server side by the push initiator. The license data or the rights object reaches the mobile device 2 by means of an over-the-air (OTA) protocol.

FIG. 2 depicts the preparation of the digital content to be protected. The digital content 20 can represent data (as e.g. for music or movies) as well as binary program code. Let P be the short description of the digital content. For protecting this content P a manipulation of the content is needed which makes said content next useless. This first manipulation 200 of the digital content P is provided by means of a content encrypting or content scrambling algorithm respectively, resulting in an encrypted con-tent package or a so-called “scrambled content package” 21, denoted as P*. The scrambled content package 21 is now useless for a specific system by applying of a secret encrypting (or scrambling) algorithm.

The (not necessarily secret) scrambling algorithm can be defined as a bijective function

s:IN→IN

that transforms a digital content segment (finally a sequence of words) into another sequence of words. Within this procedure encryption keys may be applied. This step is marked in FIG. 2 with 200. Each segment of the digital content 20 is processed by means of the scrambling algorithm resulting in encrypted content 21. The applied scrambling or encrypting function s can be a proprietary algorithm or even a well-known scrambling algorithm. Now the encrypted content package 21 is actually useless without the knowledge of the decrypting algorithm according to the encrypting algorithms.

The decrypting algorithm, also called as inverse de-scrambling algorithm can also be defined as (also bijective) function

s⁻¹:IN→IN, s(n)ε[1,N],n ε[1,N]

that transforms the sequence of N words (maybe applying necessary decryption keys) back to the original sequence of words that work on a specific system. The content protection technique of this invention scrambles the content P applying a scrambling procedure s resulting in P* with

P*(n)=P(s(n)).

The generated scrambled content will not work correctly on the system as a consequence.

The problem is if the encrypting algorithm is now cracked the digital content can freely be used or distributed without any restrictions. For this issue the present invention introduces an additional securing technique to avoid the illegal thus uneconomical distribution of the content.

This technique bases on the principle of removal of code segments from the encrypted (scrambled) content 21, called P*. To make the content protection more secure and to enable a later device-related license acquisition segments of the scrambled content will additionally be removed and separated applying a procedure 201 in FIG. 2

c:P*→(P*_{c},I)

that removes segments of the scrambled content and moves the removed content segments into a set I of removed (and scrambled) content segments in such a way, so that P* can only uniquely be reconstructed using P*_{c} 22 and I 202. For that purpose it is necessary to label every position in P*_{c} where content segments have been removed (to I) and every removed (and also scrambled) content segment (as element of I) has to be supplemented with additional information, so that it can be removed back into the original position of P*_{c}. The scrambling function s can be used to label positions in P*_{c} for removed scrambled content segments. Missing content segments can e.g. be recognized in P*_{c} if s has the result of 0 right one position before a missing segment (contained by I but not by P*_{c}) starts in P*_{c}. This step is referenced in FIG. 2 with 201, and 211 represents the label positions in the scrambled content. In such a case the missing segment has to be searched in I and put back to P*_{c} right before usage.

The step 203 shows the applying of a protected content tag to the protected content P*_{c}. This means that the protected content can now be identified by a device for starting the next steps needed for the properly use of the protected content. The protected content is herewith digitally marked to enable a device of recognizing the protected content, so that required (tamper-resistant) APIs for usage of protected content are enabled and integrated to OS actions (e.g. while program code execution or playing multimedia content).

Further, if protected content has been recognized, the program execution (e.g. driven by the OS) on the device will automatically integrate required tamper-resistant functionality e.g. to automatically de-scramble content segments or to search for removed code segments to integrate this data during program code execution.

The scrambled and shortened content package P*_{c} can be freely distributed, because it will not be possible to reconstruct the original content package P to use it on a specific system without the knowledge of s⁻¹ and I, so that a license for using P always has to include s⁻¹ and I. The package denoted as L symbolizes the raw license information data, which comprises all the information needed for decrypting and proper usage of the content. Further, the license data will be sent to a license-requesting entity by usage of an asymmetric encrypting algorithm to ensure a device-related association of the license.

Even if the encryption algorithm is cracked the removed content segments 202 causes that the content is still unusable or in case of a application it cannot be run on a specific device. The steps described above make possible the superdistribution of digital content in a much secure manner in comparison to the state of the art.

In FIG. 3 a typical infrastructure for a license-requesting entity (mobile device) is shown. The mobile device 30 comprises a private key/public key infrastructure, wherein the public key is free for distribution and the private key is stored in a tamper-resistant area, which is inaccessible from the outside. The mobile device 30 receives from somewhere a protected content package 31. For usage of the protected and encrypted content the associated license information data L is needed. This data L is stored on a protected server so that the user may send a request to the server for receiving L. The step 300 symbolizes the sending of a device-related request to the protected server of the license issuer. The request signal contains also the public key and a content identifier used to identify the associated raw license information L. Before sending the request a user confirmation may be needed but the sending can be processed automatically as well, in case the mobile device identifies protected content data.

On the server side, after receiving and processing the device-related request, the raw license information L has to be identified and the license shall only be assigned for one specific terminal or mobile device respectively, so that a license can only be used on only that one device. Assuming that a device is prepared with a freely accessible public and securely stored private key (e.g. in a protected HW area) an asymmetric encryption can be utilized to generate a device-related license for the digital content P. Let L be the license for a specific content containing the de-scrambling algorithm and the removed scrambled content segments with

L={s⁻¹,I},

and let e be a function that performs an asymmetric encryption applying the public key pₖ to a number n ε IN resulting in a new number n* ε IN with

e:(IN,pₖ)→IN,

a license L can be generated as device-related license L_{d} (see FIG. 3) if the de-scrambling algorithm is represented as sequence of words (so that the de-scrambling algorithm can be encrypted) and pₖ is the device-related public key:

L_{d}={e(s⁻¹,pₖ),Iₑ} with Iₑ={e(i,pₖ)|∀i ε I}

In this case L_{d} can only be used if the secret key of the device is known. As long as the public/private key pair is unique for every device, L_{d} can only be used with one specific device. Even if L_{d} is copied to another device, L_{d} cannot be used, because only the uniquely to pₖ matching secret key sₖ can be used for decryption of L_{d}. The device 30 receives the encrypted license information and is now ready to provide decrypting and/or execution of the protected content.

License distribution is not necessarily dependent on online connection. Licenses can also be distributed using physical media e.g. such as (secure) MMC or SD cards as long as those media support the protected binding of the license L={s⁻¹,I} to this medium, so that L can be bound to the medium using the public key of that medium resulting in Lₘ={α,I*ₑ}. If the license Lₘ shall be moved to a specific device, the binding of Lₘ to the medium has to be released and explicitly associated to the device resulting in device-related license L_{d}. The principle of device-related license association from a physical media is analogue to the procedure, which is described in FIG. 3.

FIG. 4 shows a block diagram of the procedure described in FIG. 3. The left side corresponds to the server side and the right side is the mobile device side or terminal side. The described procedure is not restricted for mobile devices; it can also be used in another imaginable infrastructure where a private key/public key environment is existent. After the mobile device identifies the existence of protected content that needs license information for usage a license request item is sent. The request, as already mentioned, contains the public key PU for the specific device and also a content Id that is needed to identify the raw license information on the server side, which is associated with the protected content. After the server receives the license request a validity check is provided. The server decides if the received data via the license request if valid, for instance: valid public key or valid content id etc. Subsequently, if the check was successfully, the protected server generates an encrypted license information package by means of the asymmetric algorithm. That is, the public key PU of the device is used to encrypt the raw license information data, containing the descrambling program, which contains the instructions how to descramble protected content, and also the removed content segments. If the validity check fails, a proper failure handling mechanism may start. After processing all these steps the protected server will send the device-related package to the specific device, which is clearly identified by the public/private key infrastructure.

Assuming that a content package P has been scrambled as introduced above to P*_{c} (that can be distributed freely) and the license L={s⁻¹,I} is available on a protected server for download requests. If a device is requesting a license the license will be prepared for that requesting device by generating the device-related license L_{d}={α,Iₑ} on the protected server applying the device specific public key pₖ, which has been requested from the server before. After license preparation on the server side L_{d} will be sent to the device (e.g. over-the-air). After the device has received L_{d}, the license can be stored on the device or on any kind of storage medium.

FIG. 5 shows the usage of protected content that is processed on the device side. The device may be a mobile device or similar, which is able to deal with protected content and to provide an asymmetric decrypting infrastructure. The reference signs 51 and 52 symbolize the protected content package, wherein 51 correspond to the content protection tag that was previously applied on the server side. The reference sign 60 is the protected data that follows from the whole package 51 and 52.

Right before content usage the tag 51 of the content package has been checked, step 400, and the device has recognized protected content P*_{c} (see FIG. 2), so that dedicated tamper-resistant APIs for de-scrambling and decryption operations are enabled, done by block 90. If the check 400 of the protected content fails, this means the output for block 90 is NO a dummy de-scrambling algorithm (as executable program) is to be loaded 80. This dummy algorithm does nothing with the incoming data; it just forwards incoming data that shall be de-scrambled. If block 90 answers YES protected content has to be used, consequently the corresponding license information is required, because it contains the algorithm (as executable program) to de-scramble the content. It additionally contains the scrambled content segments that have been removed from P*_{c}. If a content protection tag has been recognized in the content (right before first usage) the required license needs to be available. If the license is available, the device-related prepared license L_{d} is thus to be loaded to the tamper-resistant secure area 72 and it needs to be decrypted tamper-resistant.

If device-related prepared license L_{d} was not available, see block 91, the known dummy algorithm is to be loaded, see block 80. The reference sign A1 shows the area, where all operations are done just right before usage.

In the following it is assumed that the device has a dedicated and tamper-resistant hardware area, indicated in FIG. 5, (with corresponding APIs) for storing and operating
1. the device-related de-scrambling algorithm s⁻¹ (e.g. as kind of executable code), and
2. the from P*_{c} removed instructions as given in I.

Before any usage of protected content takes place, the device-related encrypted data of L_{d} needs to be decrypted 71 (as already mentioned by applying the devices secret device key) and loaded to dedicated (tamper-resistant) storage area using protected operations. After the decryption of the encrypted and device-related license information in the area A2 the scrambled removed content segments 63 and the de-scrambling (or encrypting) algorithm s⁻¹, 71 are now available. The de-scrambling algorithm may be a executable code as well.

If the license data has been written to the tamper-resistant hardware areas, the device is prepared to use the scrambled program code P*_{c}, see 60. Every scrambled sequence of words i* of P*_{c} has to be de-scrambled before it can be used 70. For that purpose the words i* (coming from P*_{c}, respectively 60) are written to a dedicated memory area, which is read from the currently loaded de-scrambling algorithm. The de-scrambling algorithm will be executed on the read words in the tamper-resistant area 70. The result 61 (after the de-scrambling has been performed whether with the matching algorithm coming from an available license or a dummy algorithm if the required license is not available) is written to a dedicated memory area that is accessed by the OS right before the content is used. If during de-scrambling (within tamper-resistant area) a label for removed content is recognized another tamper-resistant function is called automatically that (efficiently, e.g. HW-accelerated) searches for the missing content segments i ε I, which are also stored in the tamper-resistant area as explained above. If the missing content segment has been found, it will be de-scrambled and also written to the protected memory area that is read by the OS right before usage. The area A3 means that the de-scrambling operation is processed every time the protected content data is used.

The call of the tamper-resistant de-scrambling and the search for removed instructions will be done automatically if a content protection tag has been recognized right before content usage. If no content protection tag could be recognized the de-scrambling will also be called automatically, but nothing happens to the data, because the dummy de-scrambling algorithm (which automatically has been load before) keeps the data unchanged, so that not protected content can be used as usual. If a content protection tag has been recognized a corresponding license should be available, so that the only matching de-scrambling algorithm can be loaded from the license. If no license is available a dummy de-scrambling algorithm that keeps data unchanged will nevertheless process the incoming data. In that case the content cannot be used correctly, because protected content also remains scrambled. E.g. a protected application will most likely crash if an incorrect de-scrambling takes place, or a music song will not be played correctly until the music file (e.g. mp3) will be de-scrambled correctly.

FIG. 6 shows an exemplary application of the invented concept to protect games. The decrypting mechanism and the reassembling of the previously removed content segments are provided analogue to the procedure described in accordance with FIG. 5.

Another object (not illustrated) of the present invention is to provide a content developer-related tagging of copy-protected content packages. The following describes this new objective. Lets consider the case if a freely distributed (but scrambled) content package P*_{c} has to be used on a device after a license L_{d} has been acquired (from a license issuer e.g. via Internet) or is available on a physical (but protected) license distribution medium. Before any content is used on the device the content should be checked if it has been scrambled e.g. to enable an automated download of required licenses. As long as the corresponding certificate (that is required to validate certified content developers) is available on the device every scrambled content package can for example easily be tagged just by adding a header with its signature right at the beginning of any program code (regardless if it has been protected or not). If any content package P is represented as sequence of words a tagging function t can be defined as follows:

t:P→{h,sig(h)}+P with h ε IN and P ε IN

In this case h is an arbitrary identifier, which can also be represented as number. This identifier may for example contain a hash of P and other identification data, and it is simply signed by generating a hash of h (e.g. a SHA-1 hash) first and asymmetric encryption of this hash next using the private key of the content developer. The corresponding public key (to check the signature of h) is commonly distributed using a state-of-the-art certificate, which has to be available right before a tag check takes place. This (content developer) certificate, which can freely be distributed, contains the required information (such as the public key) that is necessary to check any content package on a device for a specific content developer tag.

Hence the tag check does only match for those content packages (meaning t has been applied to the checked content package), which have really been tagged by a specific content developer. To check content P for a specific developer tag the certificate of the developer is to be used to get the required information for the extraction of the identifier h and the signature sig(h) out of P. If the extracted identifier h and the signature sig(h′) have been extracted from P (as defined in the corresponding developer certificate), a hash hash(h′) has to be generated from the extracted h′ as specified in the corresponding developer certificate, and the extracted signature sig(h′) has to be decrypted decr(sig(h′),pₖ_{_{certificate}}) applying the public decryption key pₖ_{_{certificate}} as given in the certificate. Only in case of decr(sig(h′ ),pₖ_{_{certificate}})=hash(h′) the tag (in this case the decrypted identifier) does match to the corresponding developer certificate, and the content package (whether scrambled or not) can be identified. If the tag does not match (to any developer certificate on the device) it can simply be ignored or a warning can be displayed for the user.

If every content package (regardless if it is protected or not) on a device is checked for a tag right before usage the device is enabled for
checking the source of a content package, and
checking of content classes.

If the device has to be enabled for recognizing a specific tag, the device just has to use that specific developer certificate. In case of the invented content protection, the tag can be used to identify scrambled content on the one hand, and on the other hand the tag can be used for the unique identification of the developer of (protected) content, so that the device is capable of limiting the usage of content packages only to limited subgroup of developers. By applying this tagging technique for specific devices a certain party (e.g. the device vendor as device owner) can act e.g. as major content publisher that certifies content developers by assigning certificates to 3^{rd} party content developers to make their (certified) content run on said specific devices. For that purpose every device thus has to be prepared with at least one(not exchangeable) root certificate that is used for signature validation of assigned content developer certificates.

However, if scrambled content has been recognized, the system can perform a check for a valid license. If the required license is not available, the device can automatically display a message that a license is necessary to use the content, and the device can additionally offer the automatic download of the corresponding license.

Even though the invention is described above with reference to embodiments according to the accompanying drawings, it is clear that the invention is not restricted thereto but it can be modified in several ways within the scope of the appended claims.

1. A method for protecting digital content comprising:
receiving said digital content;
encrypting said digital content using a encryption algorithm resulting in encrypted content; and
generating license information associated to said encrypted content, wherein said license information is provided as one or more executable code sections, which are executable on a processor-based entity.

2. A method for protecting digital content according to claim 1, further comprising:
removing one or more content segments from said encrypted content, said reduced encrypted content resulting in protected content, and storing said one or more content segments;
providing said protected content with a protected content tag to enable identification of said protected content;
providing said protected content; and
providing said license information.

3. A method for protecting digital content according to claim 2, wherein said protected content is identifiable regardless of any manipulations caused by unauthorized parties.

4. A method for protecting digital content according to claim 2, wherein said protected content is tagged for restricted usage of said content, wherein said tag is associated with one or more originators.

5. A method for protecting digital content according to claim 4, wherein said originators are providing protected content.

6. A method for preparing license information for a license-requesting entity, wherein said license information is provided as one or more executable code sections, which are executable on a processor-based entity, comprising:
receiving said license information;
receiving a request for providing license information from said license-requesting entity; and
assigning said license information to said specific license-requesting entity using an asymmetric encryption algorithm, said license information resulting in an encrypted license information.

7. A method for preparing license information for a license-requesting entity according to claim 6, further comprising:
sending said encrypted license information to said specific license-requesting entity.

8. A method for preparing license information for a license-requesting entity according to claim 6, wherein said encrypted license information comprises code sections, which are executable exclusively on a processor-based entity.

9. A method for preparing license information for a license-requesting entity according to claim 6, wherein the encryption of the license information is based on an asymmetric public/private key infrastructure, wherein the private key is secret and the public key is freely distributable.

10. A method for preparing license information for a license-requesting entity according to claim 6, wherein the private key is associated with said license-requesting entity.

11. A method for using protected content, wherein said protected content is encrypted, comprising:
receiving protected content;
receiving a license information from a license-providing entity, wherein said license information is associated to said encrypted content, wherein said license information is provided as one or more executable code sections, which are executable on a processor-based entity; and
executing said license information in response to which said protected content is decrypted, thereby obtaining a digital content.

12. A method for using protected content according to claim 11 further comprising:
detecting that said protected content is encrypted and sending a request to a specific license-providing entity in response to said detection in order to receive said license information; and
rejecting said license information if said license information is destined for a different license-requesting entity.

13. A method for using protected content according to claim 11, wherein said protected content additionally is deprived of one or more content segments, further comprising:
executing said license information in response to which said protected content is decrypted, and re-assembling of the received one or more content segments, thereby obtaining said digital content, wherein said one or more content segments are included in said license information.

14. A method according to claim 11, wherein said license information is previously encrypted based on an asymmetric public/private key infrastructure, wherein the private key is secret and the public key is freely distributable, thereby obtaining encrypted license information.

15. A method according to claim 14, wherein said encrypted license information is device-related.

16. Method according to claim 11, comprising the additional step of identifying an assigned content provider on the basis of said digital content, which is previously identified with a originator associated tag.

17. A method for using protected content according to claim 11, wherein said sending request depends on a user confirmation operation.

18. A method for using protected content according to claim 11, wherein said re-assembling of the previously removed content is provided with respect to the information contained in said license information.

19. A method for using protected content according to claim 11, wherein said decryption algorithm is a dummy decryption algorithm that just passes through content if no license data is available.

20. A method for using protected content according to claim 11, wherein said dummy decryption algorithm passes through the protected content to another entity without any processing if no license data is available.

21. Computer program product for handling protected content, comprising program code sections for carrying out the steps of claim 1, when said program is run on a computer, a microprocessor based device, a terminal, a network device, a mobile terminal, or a portable communication enabled terminal.

22. Computer program product for handling protected content, comprising program code sections stored on a machine-readable medium for carrying out the steps of claim 1, when said program product is run on a computer, a microprocessor based device, a terminal, a network device, a mobile terminal, or a portable communication enabled terminal.

23. Software tool for handling protected content, comprising program portions for carrying out the operations of claim 1, when said program is implemented in a computer program for being executed on a microprocessor based device, processing device, a terminal device, a network device, a mobile terminal, or a portable communication enabled terminal.

24. Computer data signal embodied in a carrier wave and representing a program that instructs a computer to perform the steps of the method of claim 1.

25. A content managing system for managing use of protected content having license information associated therewith, wherein said license information provides restricted usage of said protected content, said system comprising:
at least one mobile electronic terminal device adapted to allow usage of said protected content and said license information associated therewith;
at least one protected server adapted to maintain said license information;
means for receiving a license request from said mobile electronic terminal device, wherein said means comprises an identification procedure of said mobile electronic terminal device; and
means for sending said license information associated to at least one license-requesting mobile electronic terminal device.

26. The content managing system of claim 25, wherein said mobile electronic terminal device comprises a plurality of devices, each of said devices comprising a public key used by said identification procedure.

27. Encrypting unit for generating protected content, corresponding to a digital content, and generating associated license information, comprising:
a receiver adapted to receive said digital content;
an encrypting module adapted to encrypt said digital content using an encrypting algorithm resulting in encrypted content; and
a license information generator adapted to generate license information associated to said protected content, wherein said license information is provided as one or more executable code sections, which are executable on a processor-based entity.

28. Encrypting unit according to claim 27, further comprising:
a removing module adapted to remove one or more content segments from said encrypted content resulting in protected content;
a tagging module adapted to provide said protected content with a protected content tag to enable identification of said protected content; and
means for providing said protected content and said license information.

29. Server unit for preparing license information for at least one license-requesting mobile unit comprising:
a receiver adapted to receive said license information;
a receiver adapted to receive a request for providing license information from said specific license-requesting mobile unit;
a license information assigning module adapted to assign said license information to said specific license-requesting entity using an asymmetric encryption algorithm resulting in an encrypted license information; and
a transmitter adapted to send said encrypted license information to said license-requesting mobile unit.

30. Mobile unit for using protected content, wherein said protected content is encrypted, comprising:
means for receiving protected content;
means for receiving a license information from a license-providing entity, wherein said license information is associated to said encrypted content, wherein said license information is provided as one or more executable code sections, which are executable on a processor-based entity; and
means for executing said license information in response to which said protected content is decrypted, thereby obtaining a digital content.

31. Mobile unit for using protected content according to claim 30, further comprising:
means for detecting that said protected content is encrypted and sending a request to a specific license-providing entity in response to said detection in order to receive said license information; and
means for rejecting said license information if said license information is destined for a different license-requesting entity.

32. Mobile unit for using protected content according to claim 30, wherein said protected content additionally is deprived of one or more content segments, further comprising:
means for executing said license information in response to which said protected content is decrypted, and re-assembling of the received one or more content segments, thereby obtaining said digital content, wherein said one or more content segments are included in said license information.

33. Device according to claim 30, comprising an identifier adapted to identify an assigned content provider on the basis of said protected digital content, which is previously identified with a originator associated tag, wherein said originator tag is associated with said content provider.

34. A method for protecting digital content according to claim 1, wherein said encrypted content is identifiable regardless of any manipulations caused by unauthorized parties.

35. A method for protecting digital content according to claim 1, wherein said encrypted content is tagged for restricted usage of said content, wherein said tag is associated with one or more originators.
